(19) United States
(12) Patent Application Publication
(10) Pub. No.: US 2012/0148134 A1
(43) Pub. Date: Jun. 14, 2012

(54) Medical Imaging Machine and Methods of Use

(76) Inventors: Glenn McRae, Kanata (CA); Daniel Faber, Kingston (AU); Adam Bell, Ottawa (CA)

(21) Appl. No.: 13/323,146

(22) Filed: Dec. 12, 2011

Related U.S. Application Data
(60) Provisional application No. 61/422,869, filed on Dec. 14, 2010.

(51) Int. Cl. G06K 9/00

(52) U.S. Cl. 382/131

(57) ABSTRACT

A system for medical imaging is provided and includes at least one neutron generator having a neutron generator fuel material and at least one neutron moderator material, a gantry for stationing an imaging subject, a neutron collimator attached to the neutron generator, the collimator disposed between the neutron moderator and the imaging subject, at least one gamma ray camera electrically connected to a processor-based data acquisition system, and software executing on the processor-based data acquisition system from a non-transitory physical medium, the software providing a first function for producing at least one gamma ray spectrum or image, a second function for applying correction factors to the gamma ray spectra or images, and a third function for analyzing the corrected gamma ray spectra or images to process one or more clinically relevant images of one or more targeted or general areas of the imaging subject.

### CROSS-REFERENCE TO RELATED APPLICATIONS

The present invention claims priority to a U.S. provisional patent application Ser. No. 61/422,869, entitled “Neutron Activated Single Photon Emission Computed Tomography”, filed on Dec. 14, 2010, disclosure of which is incorporated in this specification at least by reference.

### BACKGROUND OF THE INVENTION

1. Field of the Invention

The present invention is in the field of medical imaging, particularly nuclear imaging systems and pertains particularly to methods and apparatus for obtaining medical image data using non-radioactive tracer isotopes controllably activated by external neutron emission.

2. Discussion of the State of the Art

The field of nuclear medicine includes nuclear imaging systems such as single photon emission computed topography (SPECT) systems. In SPECT imaging, radioactive isotopes serving as tracer elements are injected into the subject's bloodstream and are later tracked through detection of the gamma rays consistently emitted by these isotopes due to their radioactive state when injected. Radioactive isotopes have a relatively short half-life and therefore cannot be stockpiled to ensure availability. These radioactive isotopes must be produced in a nuclear reactor. As of the time of this writing, there is unpredictability in the continued unabated availability of these radioactive isotopes for medical imaging in the medical industry. This is in part due to problems associated with nuclear reactor sites, some periodically shut down, and current methods of manufacturing those isotopes rendering them expensive to use.

Another problem with SPECT imaging is that there is no control over gamma ray emissions due to whole body doses of active-state radioactive pharmaceuticals. Radiation exposure as such cannot be reliably limited to specific areas of the subject's body.

Therefore, what is clearly needed is a nuclear imaging technique and apparatus for clinical use that allows non-radioactive (stable) tracer isotopes to be used instead of radioactive tracer isotopes, the stable isotopes activated in a controlled manner from an external neutron generator fuel.

### SUMMARY OF THE INVENTION

The problem stated above is that patient and operator safety along with adequate availability of tracer materials are desirable characteristics for a nuclear medical imaging system, but many of the conventional means for obtaining medical images in clinical settings, such as single photon emission computed tomography (SPECT) imaging systems, also create safety issues and availability issues relative to the unpredictable availability of tracer isotopes for medical industry consumption. The inventors therefore considered functional elements of a nuclear imaging system, looking for components that exhibit interoperability that could potentially be harnessed to provide high-resolution nuclear imaging in a clinical setting but in a manner that would not create safety or material handling problems.

State-of-art medical imaging systems are enabled through gamma ray detection. Most such nuclear imaging systems employ radioactive isotopes and gamma ray cameras to detect the radiation emitted by the radioactive isotopes in the imaging subject, and data processing units executing software are typically a part of such apparatus.

The present inventor realized in an inventive moment that if, during the imaging procedure, stable isotopes that might respond to a focused external stimulation could be employed instead of single-state active radioisotopes, better control over the imaging process and improvement in safety might result. The inventor therefore constructed a unique medical imaging system for clinical use that allowed non-radioactive (stable) tracer isotopes to be used as tracer elements in place of characteristic radioactive tracer isotopes, the stable isotopes activated in a controlled manner using an external neutron generator fuel. A significant improvement system process control and material handling efficiency results, with no impediment to image quality or imaging time created.

Accordingly, in one embodiment of the present invention, a system for medical imaging including at least one neutron generator having a neutron generator fuel material and at least one neutron moderator material, a gantry for stationing an imaging subject, the imaging subject containing at least one non-radioactive tracer isotope, a neutron collimator attached to the neutron generator, the collimator disposed between the neutron moderator and the imaging subject, at least one gamma ray camera electrically connected to a processor-based data acquisition system, and software executing on the processor-based data acquisition system from a non-transitory physical medium, the software providing a first function for producing at least one gamma ray spectrum or image, a second function for applying correction factors to the gamma ray spectra or images, and a third function for analyzing the corrected gamma ray spectra or images to process one or more clinically relevant, deconvolved images of one or more targeted or general areas of the imaging subject.

In one embodiment, the neutron generator fuel material is deuterium, tritium, or a combination of those materials. In a preferred embodiment, the neutron generator is repositionable about the gantry to achieve appropriate angles of incidence during beam projection. In a preferred embodiment, the neutron generator fuel and moderator materials are modular. In one embodiment, the gamma ray camera includes a collimator for filtering gamma radiation before detection. In one embodiment, the neutron collimator functions to focus the neutron beam locally on the portion of the imaging subject to be imaged.

In one embodiment, the system further includes one or more neutron reflector materials disposed about the neutron generator fuel in the neutron generator. In one embodiment, at least one neutron moderator material is heated or cooled to shift the mean energy of the neutrons in accordance with the thermal properties of the moderator to coincide with the energy level coincident with a neutron absorption resonance value or values of one or more target isotopes. In one embodiment, the system further includes one or more neutron absorption filters disposed between the imaging subject and at least one moderator material.

In one embodiment, the neutron generator fuel is pulsed and the gamma ray detection is gated to collect gamma rays between pulses. In one embodiment, the system further includes one or more safety shield apparatus integrated into the imaging architecture or disposed locally about the imaging architecture. In this embodiment, the shielding material includes one or a combination of high-density polyethylene (HDPE), lead, or boron.

According to another aspect of the present invention, In a system for medical imaging, the system including a neutron generator, a gantry for containing an imaging subject containing at least one non-radioactive tracer isotope, and at least one gamma ray camera electrically connected to a processor-based data acquisition system, a method for processing a gamma ray spectrum or image to form a deconvolved two-dimensional or three-dimensional image including the steps (a) aided by software running on the data acquisition system, applying a neutron shelf-shielding correction factor to the gamma ray spectrum or image, (b) aided by the software of step (a), applying a gamma ray attenuation correction factor to the gamma ray spectrum or image, (c) filtering the image data of noise, and (d) processing the image data of step (c) to improve discernability of the image.

In one aspect of the method, steps (c) and (d) are performed with the aid of the software of step (a). In one aspect, the neutron emitter includes at least one neutron moderator material and a collimator disposed ahead of the moderator material to focus the neutron beam locally on the portion of the imaging subject being imaged. In this aspect, at least one neutron moderator material is one or a combination of HDPE, lead, or boron.

In one aspect of the method, the neutron generator is pulsed and the gamma ray detection is gated to collect gamma rays between pulses. In one aspect, in step (c), noise is filtered using a Compton suppression system and or a triple or double-energy window scatter filter. In one aspect, step (a) and step (b) are interchangeable steps. In another aspect, steps (a) and (b) are run concurrently.

In one embodiment of the system, the neutron generator fuel material is Californium, Americium-Beryllium, or a combination of those materials. In one aspect of the method wherein the neutron emission is pulsed, the gamma rays are collected during the neutron generator pulses. In a variation of that aspect, the gamma rays are collected during one or more specified time slices taken during a specified pulsing window of the neutron generator.

In one embodiment of the system, the imaging subject is moveable relative to the neutron collimator to achieve appropriate angles of incidence during beam projection. In one embodiment of the system, the neutron moderator materials contain high levels of deuterium, heavy water, or deuterated HDPE. In one embodiment of the system, the at least one tracer isotope is natural samarium (SM) or ¹⁴⁹SM. In one aspect of the method, the at least one tracer isotope is natural SM, or ¹⁴⁹SM.

In one embodiment of the system, the at least one tracer isotope is gadolinium or europium. In one embodiment of the system, the at least one tracer isotope is carried by ethylenediaminetetramethylenephosphonic (EDTMP) acid. In one aspect of the method, the at least one tracer isotope is also carried by EDTMP acid.

### BRIEF DESCRIPTION OF THE DRAWING FIGURES

FIG. 1 is a perspective view of a neutron-activated single photon emission computed tomography system.

FIG. 2 is a block diagram illustrating orientation of the neutron generator of FIG. 1 relative to the imaging subject resting upon the gantry table of the system of FIG. 1.

FIG. 3 is a process flow diagram depicting steps for acquiring images through prompt gamma ray neutron activation according to the embodiment of FIG. 1.

FIG. 4 is a process flow chart depicting steps for removing noise from imaging data according to the embodiment of FIG. 1.

### DETAILED DESCRIPTION

The inventors provide a unique system and accompanying methods for medical imaging that enable construction of deconvolved medical images for clinical use. The present invention will be described in enabling detail using the following examples, which may describe more than one relevant embodiment falling within the scope of the present invention.

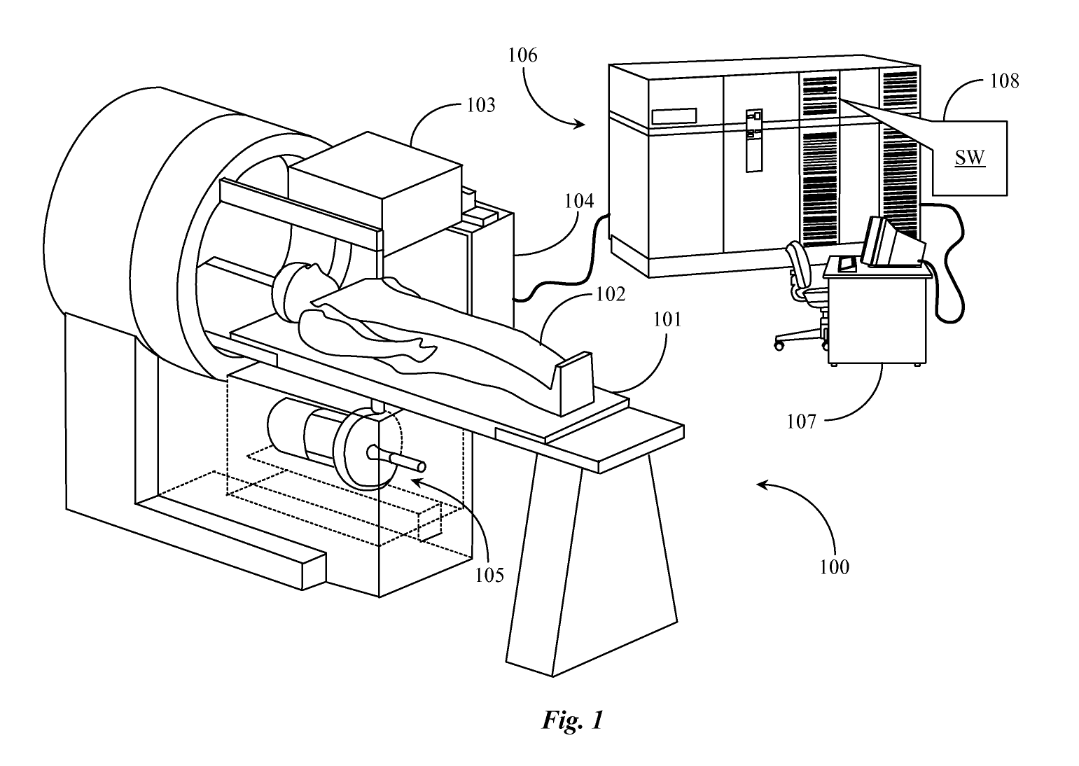

FIG. 1 is a perspective view of a neutron-activated single photon emission computed tomography (nSPECT) system 100. The nSPECT system 100 is a hybrid medical imaging system that uses prompt gamma-ray neutron activation (PGNA) to activate non-radioactive tracer isotopes rather than typical gamma ray detection associated with injected radioactive tracer isotopes typically used in SPECT imaging.

A gantry 101 similar to that of a SPECT imaging system is illustrated in perspective and supports an imaging subject 102 on the gantry table for medical imaging. The rear portion of gantry 101 includes at least one rotable ring for rotating one or more connected gamma-ray detectors (gamma cameras) to certain positions about imaging subject 102 as is consistent with SPECT imaging systems. The gantry table supporting the patient is linearly adjustable relative to a pair of gantry-supported gamma camera assemblies 103 and 104. There may be more or fewer gamma camera assemblies provided and connected to gantry 101 without departing from the spirit and scope of the present invention. A gantry that supports one or more rotable gantry rings is not absolutely required to practice the present invention as other architectures currently used in medical imaging can be modified with a neutron generator to practice the present invention.

In this example, the patient table may be caused to move linearly relative to the longitudinal axis of the gantry, as may be the case with typical gantry systems. However, the architecture of system 100 may vary widely in design without departing from the spirit and scope of the present invention. Vertical architectures may also be employed as well as various combinations of architectures adapted for different types of nuclear imaging systems including hybrid SPECT imaging systems that include either magnetic resonance (MR) imaging and or computed tomography (CT) components. The spatial orientation of components in the architecture of system 100 should in no way be construed as a limitation to the practice of the present invention.

A neutron generator 105 is provided and mounted beneath the gantry table in this embodiment. Generator 105 is adapted to generate fast neutrons that are then moderated using one or more of a variety of moderator materials (not illustrated) and then projected or beamed toward the imaging subject 102, more specifically at a targeted area of the subject that is the target of imaging. In this case, the subject has been injected with one or more non-radioactive isotopes that are then activated via neutron bombardment to emit characteristic gamma rays for detection and image construction.

In this embodiment, generator 105 is rotable about an axis parallel to the longitudinal axis of the gantry. This enables focus of the neutron beam at specific parts of imaging subject 102 by using a combination of positioning the gantry table linearly along the longitudinal axis of the gantry and rotating the neutron generator along a radius that is substantially perpendicular to the longitudinal axis of the gantry. In this way specific areas of the subject may be studied in isolation of non-targeted areas. In other embodiments, neutron generator 105 may be mounted on an arm connected to gantry 101, on a rotable ring traveling about a race. In this case, generator 105 is an electric neutron generator based on a deuterium-deuterium (D-D) or deuterium- tritium (DT) reaction.

Generator 105 is adapted to produce a beam of fast neutrons through one or more moderator materials placed in direct line-of-sight of the neutron beam. Moderator materials are not illustrated in this example. Such moderator materials have a low neutron absorption cross-section. In addition to being used as moderators, both Carbon and Beryllium can be used as neutron reflectors around the neutron generator fuel in generator 105. Lead may also be used as a neutron reflector, particularly for reflecting fast neutrons. Beryllium and Lead can also be used as neutron multipliers via favorable reaction with fast neutrons.

Gamma ray detectors 103 and 104 have data connection to a processor based computing system 106 that includes a technician workstation 107. Processor-based computing system 106 and gamma ray detectors 103 and 104 comprise a processor-based data acquisition system suitable for the purpose of detecting gamma rays and creating useable images from the image data collected in the form of one or more gamma ray spectra. In one embodiment, gamma cameras 103 and 104 are connected directly to a computer based on workstation 107 and computing system 106 may not be required in order to practice the present invention.

A software application 108 is provided and resides on a non-transitory physical medium on computing system 106. Software 108 provides three basic functions. Software 108 provides a function for producing at least one gamma ray spectrum for analysis. SW 108 provides another function for applying correction factors to the gamma ray spectrum produced by the first function. Such correction factors may include a neutron self-shielding correction factor and a gamma ray attenuation correction factor. Such correction factors are required in the image development process. Neutron scatter and absorption through the imaging subject is measured and or calculated to compute a neutron self-shielding correction factor.

Neutron scatter and absorption can be calculated via Monte Carlo code using a model of an imaging subject such as subject 102 that may or may not be constructed with the use of data from CT or MR imaging of the patient. Data from a secondary gamma camera energy window may also be used for calculating neutron scatter and absorption. In the case where CT and or MRI data are not available, the neutron self-shielding correction factor may be calculated with an iterative algorithm. The Monte Carlo patient model may also be modified with the aid of a 3D laser scan of the imaging subject on the nSPECT imaging machine gantry 101.

Gamma ray attenuation correction factors may be calculated and applied to the image deconvolution process to enhance contrast and overall image quality. Gamma ray attenuation correction factors can be calculated using the methods currently used for SPECT attenuation correction with hybrid imaging systems and or by using a multi-peak analysis method. Moreover, the basic method to correct a PGNA gamma ray spectrum and to produce a deconvolved image comprises the steps of applying a neutron self-shielding correction factor and applying a gamma ray attenuation correction factor. Correction factors consist of one or more multi-dimensional arrays of multiplication factors, which are convolved with the image data. Correction factors may be applied to individual projection images or to the fully assembled 3D images. Correction factors can be applied before or after filtering and processing images. It is not absolutely required to produce a gamma ray spectrum in order to obtain a rough image from gamma ray detection. Some gamma cameras may initially produce one or more images without specifically taking gamma ray spectra. However, processing gamma ray spectra to form images may be more effective when the goal is production of a high-resolution deconvolved image.

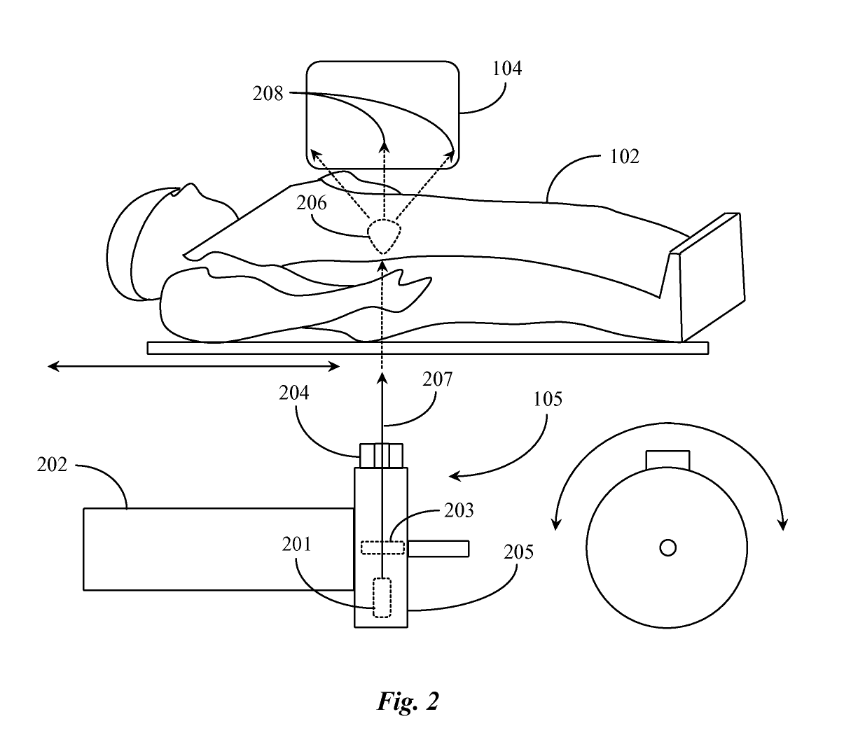

FIG. 2 is a block diagram illustrating orientation of the neutron generator of FIG. 1 relative to the imaging subject resting upon the gantry table of the system of FIG. 1. Neutron generator 105 includes a fuel material 201 for a reaction to emit fast neutrons. Fuel material 201 is isotropic and the neutron output is characterized at 1.6×10⁹ neutrons @ 2.45 MeV. It should be noted herein that the output might vary according to different designs for neutron generation. It should also be noted that in some designs for neutron generation, radioactive neutron source materials might be used. The neutron generator fuel is at the center of the tube or body 202 of the generator. In one embodiment, the neutron generator fuel may be Californium, Americium-Beryllium, or a combination of those materials. As described further above, one or more moderator materials 203 are located in front of fuel 201.

For neutron capture resulting in a photon emission, the emitted neutrons should be at the lowest energy practical. The probability of capture in a material is generally higher for low neutron energies. An exception might be the case of ¹⁴⁹ samarium, one of the preferred target isotopes, which is characterized by resonate absorption peaks. More particularly, lower energy neutrons are more easily captured. Fast neutrons are thermalized with moderating materials. Water may be used to thermalize fast neutrons in the fewest number of collisions but heavy water (D2O) captures far fewer thermal neutrons and thus has the highest moderating ratio.

In one aspect, generator 105 employs neutron reflectors (not illustrated but assumed present). Beryllium and lead are employed as fast and epithermal neutron reflectors and neutron multipliers located around the neutron generator. Beryllium is also useful as a moderating material. Both elements have high neutron scattering and low neutron absorption cross-sections. Possible moderators include water, HDPE heavy water, beryllium and carbon.

Neutron generator 105 emits fast neutrons through moderator materials 203 culminating in a neutron beam 207 directed toward imaging subject 102. A collimator 204 is provided and removably attached or affixed to generator 105. Collimator 204 is adapted to focus the emitted neutron beam only on the portion of subject 102 that is being imaged. In this case, the neutron beam is focused on a small area 206 within the body of imaging subject 102. The neutrons collide with non-radioactive isotopes used as tracer isotopes and collisions cause the isotopes to emit characteristic gamma rays. Non-radioactive tracer isotopes used in PGNA imaging may include but are not limited to natural samarium (SM), ¹⁴⁹SM, gadolinium and europium.

Collimator 204 helps to reduce the instances of radioactive exposure to parts of the body of the imaging subject that are not subject of the imaging procedure. Shielding may also be provided to the imaging subject to protect certain areas of the body.

Collimator 204 is, in a preferred embodiment, a variable-geometry neutron collimator. The collimator functions to shape the neutron beam to minimize the exposure of tissue that is not being targeted for imaging as described above. In this case, it is preferred that the element(s) used for the neutron collimator have a low radiative neutron capture cross-section and a high (n, alpha) cross-section. Alpha particles are Helium nuclei with a +2 charge and are very easily shielded. Alternatively, the neutron shielding element(s) may have a high radioactive neutron capture cross-section if the resulting spectrum of emitted gamma rays are low-energy and easily shielded.

Despite moderating and shielding, it is possible that some fast neutrons will still manage to reach a gamma camera such as gamma camera 104. Interactions between fast neutrons and the nuclei of the Nal (TI) detector crystal of the camera will indirectly produce a signal in the detector, which will contribute to noise in the image. In order to reduce this noise, the gamma camera acquisition time may be gated to coincide with the off time after a neutron pulse is emitted from neutron generator 105. Thermal neutrons build up over time after a pulse of fast neutrons, due in part, to the many collisions that must occur before the neutron is thermalized. The fast and thermal neutron peak fluxes occur at distinct and separate times, so the period of time during which the fast neutrons dominate is ignored. Conversely, the detector is active during the period of time when thermal neutrons and PGNA particles dominate the detector.

Collimator 204 may comprise LbN, which has the highest Li-atom density, making it very useful as a collimator material. A born-lead hybrid shield would also work very well as a collimator material, particularly when shielding against thermal neutrons and photons. In addition to being used in the collimator, these materials are ideal for shields, which are used to protect sensitive regions, such as the spinal cord and genitals. Such shielding would be similar to the protective pads used currently in X-ray shielding.

In one embodiment, neutron filters (not illustrated) are employed in addition to the collimator to produce neutron energy spectra designed to achieve an ideal energy spectrum. This may be a highly thermalized spectrum or a spectrum corresponding to the tracer isotope's neutron-capture resonance at the target tissue depth. In this way neutrons that would otherwise be absorbed in surface tissue with no added benefit or would deliver too much dose are preferentially restricted from leaving the moderator at the site of the filter.

Examples of neutron filter materials and the resulting average neutron energy are silicon-sulfur (54 keV), silicon-titanium (144 keV), and sulfur (75 keV). The filter is located between the moderator and the patient within the area defined by the neutron collimator. Different filter materials may be employed in a specific pattern designed to optimize the neutron flux for multiple depths simultaneously, depending on the depth of the target tissue at various locations. One clinical instance of where this type of shielding may be employed is a whole-body bone scan. Additionally, the moderator will have the capacity to be heated or cooled in order to shift the mean energy of thermalized neutrons to higher or lower energies. This is useful in order to increase the sensitivity of the target isotope. In this case, heating or cooling the moderator serves to match neutron energy to isotope neutron absorption resonance. Moderator heating, for example, can also be performed in order to shift the mean neutron energy in the moderator closer to the transparency energy of the filter or filters employed so that the filter or filters reject fewer neutrons.

Samarium (Sm), more particularly, the isotope ¹⁴⁹Sm has a 13.8% natural abundance and is an ideal target for PGNA planar and SPECT imaging. It possesses a very large thermal neutron PGNA cross-section of approximately 40,000 barns. Sm has a cross-section of approximately 129,000 barns at its 0.1 eV resonance, and it has two primary gamma emissions at 334 keV (86% probability) and 440 keV (52% probability). It is noted herein that these gammas are above the ideal range of 100-250 keV for a lcm thick Na (TI) gamma camera, however they are still low enough in energy to be useful for imaging. Moreover, Sm already has a history of use in combination with a bone-seeking molecule ethylene diamine tetra ethylene phosphonic acid (EDTMP). Combined with ¹⁵³Sm, they produce the bone-seeking radiopharmaceutical, ¹⁵³Sm=EDTMP, which is used for palliative treatment of bone metastases and, in a secondary capacity, for post-treatment SPECT imaging. For diagnostic bone imaging, the stable ¹⁴⁹Sm may replace radioactive ¹⁵³Sm, for nSPECT since the isotopes are chemically identical.

Sm and its bone-seeking molecule, EDTMP, already have a history of medical application, primarily as a cancer treatment drug using the artificial ¹⁵³Sm radioisotope, but also for limited bone imaging. This is to say that clinical trials for the application of ¹⁴⁹SM=EDTMP to medical imaging may be bypassed, or at least accelerated. In a preferred application, highly enriched ¹⁴⁹Sm would be used, otherwise natural abundance Sm could be used. There are seven isotopes that form natural abundance samarium, all of which are susceptible to PGNA techniques. ¹⁴⁹Sm is dominant, to the point where the gamma photons from the other 6 isotopes may be nearly undetectable in PGNA analysis due to the quantity of ¹⁴⁹Sm photons produced. Therefore, if natural abundance Sm is used, a higher quantity of the Sm-EDTMP pharmaceutical might be required, but the performance of the imaging procedure would be otherwise unaffected.

A difference between using radioactive isotopes (SPECT) verses non-radioactive isotopes (nSPECT) is that larger quantities of non-radioactive nSPECT tracers may be required to achieve images of equivalent quality as SPECT images for acceptable patient dose rates. In empirical testing, it has been shown that oral doses of EDTMP of 100 mg/kg daily over 13 weeks have no toxic effects in laboratory rats. At a daily dose of 500 mg/kg, the rats had developed a mild case of anemia by the end of the 13-week regimen. The rats had a full recovery once the dosing was stopped. This study was undertaken to assess the potential toxic side effects of EDTMP in drinking water since it is a common ingredient in household detergents, among other products. That same study demonstrated that 6.31% of EDTMP is absorbed by tissue when consumed orally, with half of that being absorbed by the skeleton. EDTMP has been reported to have a 520-hour half-life in bone. In non-osseous tissue (muscle, liver, heart, etc.), EDTMP is cleared out within a few hours.

Further to the above, for an average, 70 kg person, a 7000 mg (0.0128 mol) daily oral dose of EDTMP chelated with a ¹⁴⁹Sm atom in a 1:1 molar ratio can deliver 60 mg of ¹⁴⁹Sm to the skeleton. After a weeklong daily dosing regimen, this would result in 380 mg of ¹⁴⁹Sm present in the skeleton. The daily dose can be spread over multiple doses throughout the day if necessary, though an empty stomach is optimal for drug delivery to the skeleton. EDTMP will bind to Ca and Fe in the stomach and intestines if they are present. ¹⁴⁹Sm=EDTMP can also be administered intravenously with a much higher rate of uptake in tissue. Intravenous delivery of tracers is common in radioisotope-based SPECT imaging.

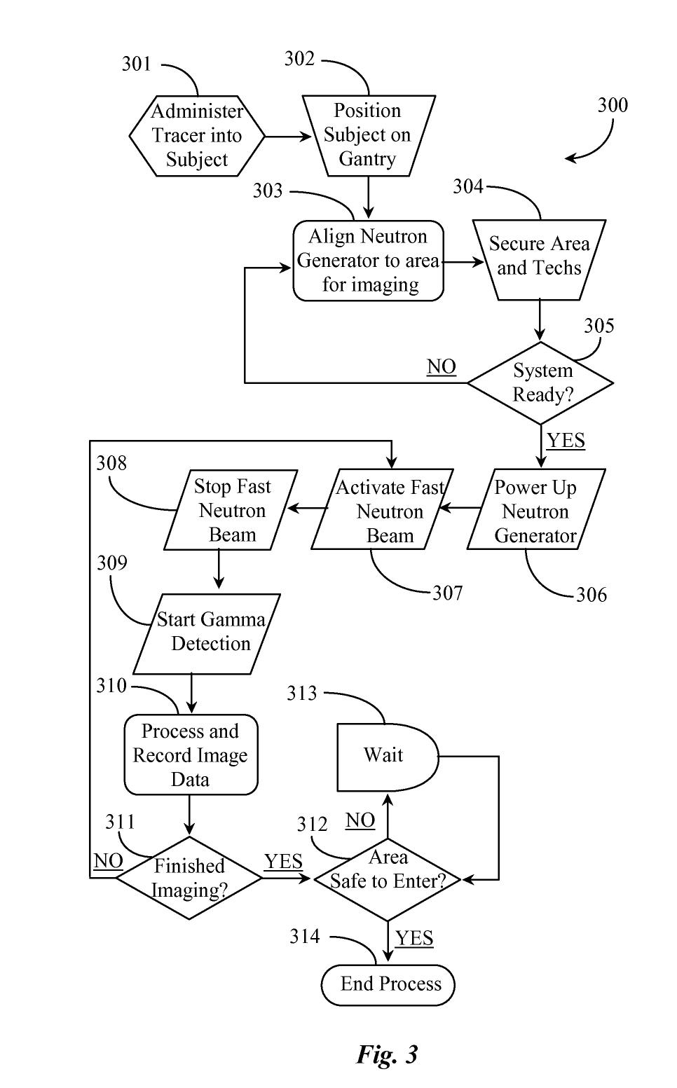

FIG. 3 is a process flow diagram depicting steps for acquiring images through prompt gamma ray neutron activation according to the embodiment of FIG. 1. At step 301, non-radioactive tracer isotope(s) are administered into the imaging subject. The isotopes may be infused into the imaging subject, injected into the imaging subject or may be orally administered without departing from the spirit and scope of the present invention. At step 302, the imaging subject is placed on the gantry of the nSPECT imaging system of the present invention. At step 303, the neutron generator is aligned relative to the specific area of the imaging subject that is targeted. The neutron generator may be set in motion, for example, in a whole body scan. In one embodiment, the neutron generator may be manually positioned.

At step 304, the areas around the system and imaging subject, as well as area around any technicians that are operating and or monitoring the imaging process are secured for safety using the appropriate shielding. Technicians should enter appropriate safe zones such as a shielded control room, for example. Suitable shielding may include boron, lead, HDPE, or other such materials mentioned further above. At step 305, a decision is made as to whether the system is ready to begin the neutron activation process for imaging. If the system is not ready to begin imaging at step 305, the process may resolve back to step 303 to ensure proper alignment and shielding is in place according to specifications. If the system is ready to begin the imaging process at step 305, then the neutron generator is powered up at step 306.

At step 307, the fast neutron generator is activated to emit fast neutrons, which are moderated to thermal range to the targeted tracer of step 301. After a defined period or pulse, the neutron beam may be stopped at step 308. Pulsing the neutron emissions may be performed in order to reduce noise in the resulting images. At step 309 the gamma detection process is started while the neutron generator is in the off state or not emitting neutrons. In another embodiment the neutron generator may emit neutrons continually rather than being pulsed.

At step 310, the data acquisition system aided by SW processes and records image data. This process involves several sub-steps not limited to application of various filters, calculation of self-shielding factors for neutrons and attenuation correction for the emitted gamma rays. As the image data are processed, the images may be displayed on screen for the monitoring technician or doctor or other authorized personnel.

At step 311, the decision is made as to whether the imaging process is finished.

The attending technician or doctor monitoring the images created thus far in the imaging process may make this decision. If at step 311, it is determined that the imaging process is not yet finished, the process may resolve back to step 307 to continue the active imaging process. It is important to note that in the pulsed embodiment, gamma detection occurs only when the neutron generator is in the negative pulse mode of step 308 or not emitting neutrons. It is also noted herein that steps 307 through 309 may be repeated in sequence many times before the imaging process is completed. A step for stopping the gamma ray detection process in coordination with step 307 may be provided so that the gamma cameras are not on when the neutron pulse is currently active.

If the imaging process is finished at step 311, then at step 312 a decision is made as to whether it is safe or not safe to enter the area around the imaging machine. If at step 312 it is determined that it is not yet safe for the technician to enter the imaging area, the process resolves to step 313 for a delay. After a set period, the process moves back to step 312. If it is deemed safe to enter the area at step 312, then the process may be allowed to terminate at step 314. nSPECT enables just the isotopes in the targeted region to emit characteristic gamma rays required for imaging, unlike the use of radioactive isotopes that continually emit gamma rays regardless of where they are in the imaging subject including gamma ray emission before the imaging process begins and after the imaging process ends. By gating the process with respect to alternating between pulse emission of neutrons and gamma detection sequences, much noise can be eliminated with respect to image data processing.

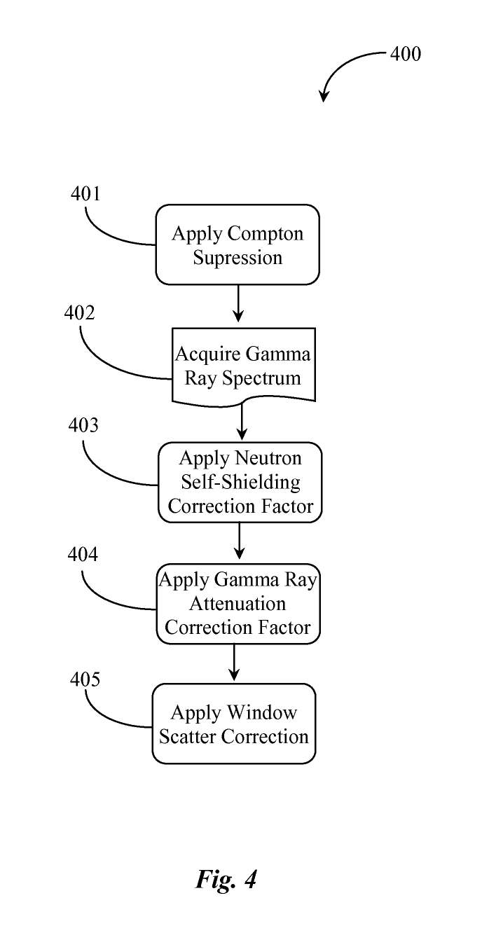

FIG. 4 is a process flow chart depicting steps for removing noise from imaging data according to the embodiment of FIG. 1. This process assumes that a gamma ray spectrum has been created by gamma detection with the aid of SW. At step 401, the system may apply a Compton Count suppression technique to reduce unwanted noise from the image data. At step 402, the data acquisition and processing component of the system of the invention acquires at least one gamma ray spectrum for analysis using PGNA to produce the spectrum. At step 403, the system aided by SW calculates and applies a neutron self-shielding correction factor to the spectrum to remove some unwanted noise due to neutron scatter and absorption. Neutron scatter and absorption can be calculated via Monte Carlo code using a model of an imaging subject that may or may not be constructed with the use of data from CT or MR imaging of the patient. Data from a secondary gamma camera energy window may also be used for calculating neutron scatter and absorption. In the case where CT and or MRI data are not available, the neutron self-shielding correction factor may be calculated with an iterative algorithm. The Monte Carlo patient model may also be modified with the aid of a 3D laser scan of the imaging subject on the nSPECT imaging machine gantry.

The neutron self-shielding correction factors can enhance image reconstruction for nSPECT in both computed tomography and planar imaging configurations. Neutron scattering, absorption, and beam divergence causes the neutron flux to vary with the location in the image subject. In SPECT imaging, the location of radioactivity is not important rather, it is the location of the tracer itself that is important to medical practitioners. The radioactivity of the tracer is simply a good way of reliably locating and quantifying the tracer throughout the body. Within nSPECT, the activity of a specific volume of tissue is now dependent on more than just the quantity of tracer present. In fact, it is dependent on the intensity of the neutron flux in that volume as well. The neutron flux must be known with reasonable accuracy to determine the quantity of tracer present in a volume of tissue. Neutron self-shielding correction factors are a way of correcting (by amplifying or reducing) the activity in an nSPECT image by accounting for the variation in neutron flux with respect to some base line value.

The neutron flux in a volume of tissue can be calculated in different ways depending on the information available. If anatomical information about the patient was gathered simultaneously to the nSPECT information, then the anatomical data can be used to determine the density of hydrogen nuclei as it varies throughout the body. Using a high-energy window during the nSPECT acquisition, the number of hydrogen 2.2 MeV counts can be measured in addition to the tracer isotope counts. Using this hydrogen count data with the hydrogen nuclei density, the neutron flux can be estimated at every location in the body. The anatomical information can be gathered by using a CT or MRI scanner (either independent or part of an nSPECT hybrid system). In one embodiment, a 3D laser scanner can provide the anatomical data.

Alternatively, if detailed anatomical data is unavailable, then the physical characteristics of the image subject can be calculated based on clinical observation and or the general shape of a resulting nSPECT image, particularly in the case of whole-body imaging. These physical characteristics are then used to modify a detailed model of a reference subject in a Monte Carlo simulation code such as MCNP. Then, based on calibration data of the neutron generator fuel(s) of the nSPECT machine, a simulation is run, which estimates the neutron flux distribution throughout the patient over the course of the imaging procedure. This is not unlike the Monte Carlo simulations that may be utilized to study the expected patient dose of tracers for nSPECT imaging procedures.

At step 404, the system aided by SW calculates and applies a gamma ray attenuation correction factor to the acquired gamma ray spectrum. As described further above, gamma ray attenuation correction may be performed before actual image reconstruction. Steps 403 and 404 may be performed in reverse order than stated or concurrently without departing from the spirit and scope of the present invention on one or more acquired gamma ray spectra carrying the same imaging data. At step 405, the system may apply double or triple window scatter correction.

It will be apparent to one with skill in the art that the nSPECT imaging system of the present invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

What is claimed is:

1. A system for medical imaging comprising:
at least one neutron generator having a neutron generator fuel material and at least one neutron moderator material;
a gantry for stationing an imaging subject, the imaging subject containing at least one non-radioactive tracer isotope;
a neutron collimator attached to the neutron generator, the collimator disposed between the neutron moderator and the imaging subject;
at least one gamma ray camera electrically connected to a processor-based data acquisition system; and
software executing on the processor-based data acquisition system from a non-transitory physical medium, the software providing:
a first function for producing at least one gamma ray spectrum or image;
a second function for applying correction factors to the gamma ray spectra or images; and
a third function for analyzing the corrected gamma ray spectra or images to process one or more clinically relevant, deconvolved images of one or more targeted or general areas of the imaging subject.

2. The system of claim 1, wherein the neutron generator fuel material is deuterium, tritium, or a combination of those materials.

3. The system of claim 1, wherein the neutron generator is repositionable about the gantry to achieve appropriate angles of incidence during beam projection.

4. The system of claim 1, wherein the neutron generator fuel and moderator materials are modular.

5. The system of claim 1, wherein the gamma ray camera includes a collimator for filtering gamma radiation before detection.

6. The system of claim 1, wherein the neutron collimator functions to limit the neutron beam locally to the portion of the imaging subject to be imaged.

7. The system of claim 1, further including one or more neutron reflector materials disposed about the neutron generator.

8. The system of claim 1, wherein the at least one neutron moderator material is heated or cooled to shift the mean energy of the neutrons in accordance with the thermal properties of the moderator to coincide with the energy level coincident with a neutron absorption resonance value or values of one or more target isotopes.

9. The system of claim 1, further including one or more neutron absorption filters disposed between the imaging subject and the at least one moderator material.

10. The system of claim 1, wherein the neutron generator is pulsed and the gamma ray detection is gated to collect gamma rays between pulses.

11. The system of claim 1, further including one or more safety shield apparatus integrated into the imaging architecture or disposed locally about the imaging architecture.

12. The system of claim 11, wherein the shielding material includes one or a combination of high-density polyethylene (HDPE), lead, lithium, or boron.

13. In a system for medical imaging, the system including a neutron generator, a gantry for containing an imaging subject containing at least one non-radioactive tracer isotope, and at least one gamma ray camera electrically connected to a processor-based data acquisition system, a method for processing a gamma ray spectrum or image to form a deconvolved two-dimensional or three-dimensional image comprising the steps:
(a) aided by software running on the data acquisition system, applying a neutron shelf-shielding correction factor to the gamma ray spectrum or image;
(b) aided by the software of step (a), applying a gamma ray attenuation correction factor to the gamma ray spectrum or image;
(c) filtering the image data of noise; and
(d) processing the image data of step (c) to improve discernability of the image.

14. The method of claim 13, wherein steps (c) and (d) are performed with the aid of the software of step (a).

15. The method of claim 13, wherein the neutron generator includes at least one neutron moderator material and a collimator disposed ahead of the moderator material to limit the neutron beam locally to the portion of the imaging subject being imaged.

16. The method of claim 15, wherein the at least one neutron moderator material is HDPE, beryllium, carbon, heavy water, water, or lead.

17. The method of claim 13, wherein the neutron generator is pulsed and the gamma ray detection is gated to collect gamma rays between pulses.

18. The method of claim 13, wherein in step (c), noise is filtered using a Compton suppression system and or a triple or double-energy window scatter filter.

19. The method of claim 13, wherein in step (a) and step (b) are interchangeable steps.

20. The method of claim 13, wherein steps (a) and (b) are run concurrently.

21. The system of claim 1, wherein the neutron generator fuel material is Californium, Americium-Beryllium, or a combination of those materials.

22. The method of claim 17, wherein the gamma rays are collected during the neutron generator pulses.

23. The method of claim 17, wherein the gamma rays are collected during one or more specified time slices taken during a specified pulsing window of the neutron generator.

24. The system of claim 1, wherein the imaging subject is moveable relative to the neutron collimator to achieve appropriate angles of incidence during beam projection.

25. The system of claim 1, wherein the neutron moderator materials contain high levels of deuterium, heavy water, or deuterated HDPE.

26. The system of claim 1, wherein the at least one tracer isotope is natural samarium (SM) or ¹⁴⁹SM.

27. The method of claim 13, wherein the at least one tracer isotope is natural SM, or ¹⁴⁹SM.

28. The system of claim 1, wherein the at least one tracer isotope is gadolinium or europium.

29. The system of claim 1 wherein the at least one tracer isotope is delivered using a carrier molecule.

30. The method of claim 13 wherein the at least one tracer isotope is delivered using a carrier molecule.

31. The system of claim 29 wherein the carrier molecule is the bone-seeking molecule ethylene diamine tetra methylene phosphonic (EDTMP) acid.

32. The method of claim 30 wherein the carrier molecule is the bone-seeking molecule ethylene diamine tetra methylene phosphonic (EDTMP) acid.
